(19) United States
(12) Patent Application Publication
(10) Pub. No.: US 2024/0289181 A1
(43) Pub. Date: Aug. 29, 2024

(54) POWER CONSUMPTION-BASED RATE LIMITING

(71) Applicant: Intel Corporation, Santa Clara, CA (US)

(72) Inventors: Mateusz Polrola, Lodz (PL); Maksim Lukoshkov, Clarecastle (IE); Ciunas Low Bennett, Mallow (IE)

(73) Assignee: Intel Corporation, Santa Clara, CA (US)

(21) Appl. No.: 18/655,942

(22) Filed: May 6, 2024

(51) Int. Cl. G06F 9/50; G06F 1/3206

(52) U.S. Cl. CPC G06F 9/5083; G06F 1/3206; G06F 9/505

(57) ABSTRACT

A hardware accelerator device is provided with accelerator hardware including a first component to be used in execution of a first job and first power monitoring circuitry to monitor power consumption at the first component associated with execution of the first job. The hardware accelerator further includes a usage controller to limit use of the accelerator hardware by the first job based at least in part on the measured power consumption at the first component associated with execution of the first job.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

### BRIEF DESCRIPTION OF THE DRAWINGS

FIG. 1 illustrates a block diagram of components of a datacenter in accordance with certain embodiments.

FIG. 2 is a simplified block diagram of an example platform including a hardware accelerator.

FIG. 3 is a simplified block diagram illustrating an example logical stack for a hardware accelerator used by one or more applications in an example computing platform.

FIG. 4 is a simplified block diagram illustrating a hardware accelerator.

FIG. 5 is a simplified block diagram illustrating an example hardware accelerator with integrated power consumption monitoring hardware blocks.

FIG. 6 is a simplified flow diagram illustrating an example technique for monitoring power consumption at a hardware accelerator.

FIG. 7 illustrates a block diagram of an example processor device in accordance with certain embodiments.

Like reference numbers and designations in the various drawings indicate like elements.

### DETAILED DESCRIPTION

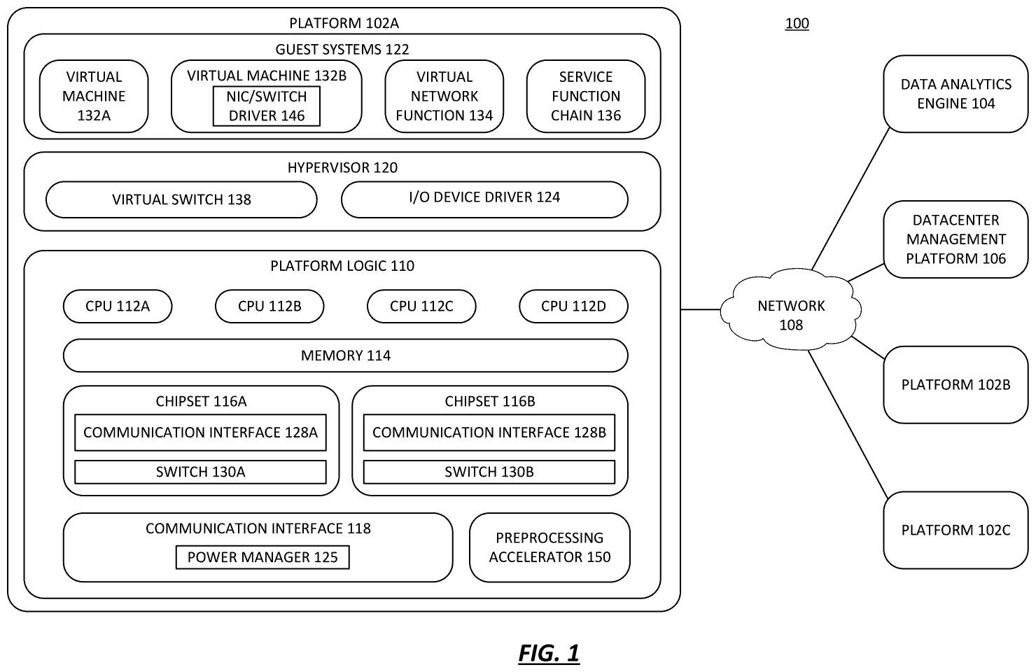

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators (e.g., a smart NIC, infrastructure processing unit (IPU), etc.), among other example enhancements.

Each platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch). In still other examples, the platform or portions of the platform (including an integrated (e.g., on-die) hardware accelerator (e.g., 150) may be integrated within other computing systems and form factors, including personal computers, set top boxes, gaming system, smart appliances, IoT systems, smart phones, vehicle onboard systems, among other examples.

CPUs 112 may each comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs. In some implementations, application to be executed using the CPU (or other processors) may include physical layer management applications, which may enable customized software-based configuration of the physical layer of one or more interconnect used to couple the CPU (or related processor devices) to one or more other devices in a datacenter system.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may each comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on each CPU.

Chipsets 116 may each include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features. Other controllers may also be provided and/or integrated in blocks of the platform. For instance, as discussed in more detail herein, a hardware accelerator device 150 may include power consumption monitoring and management logic (e.g., implemented in hardware and/or firmware) to rate limit use of the hardware accelerator based on tenant power consumption, among other examples.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 may include a group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

In some implementations, the data system 100 may include one or more hardware accelerator devices (e.g., 150) to assist with tasks of the data system 100 and to “accelerate” certain common tasks of the system 100 and thereby increase the overall efficiency of the system and applications executed on the system (e.g., from a latency, bandwidth, or power perspective). In one example, an accelerator device 150 may be provided on the data system 100, with hardware-implemented logic to perform a set of functions or algorithms commonly used within the data system. As an example, the accelerator 150 may include circuitry to perform compression/decompression, encryption/decryption, networking, data transformation, memory management, machine learning-related tasks (e.g., training, inferences, neural network modeling, etc.), and other tasks. In some examples, the accelerator 150 may be included on a system on chip (SoC) device, a plug-in card, an IPU or smart networking device, among other examples. SoC devices, as referred to herein, may include devices implemented on a same package or same die and including various hardware components or blocks to implement a particular system. In some implementations, the accelerator device 150 may include features similar to a QuickAssist™ accelerator device, Huawei™ SmartCompression™ or SmartDedupe™, hardware, among other examples.

The exponential growth of data- and compute-intensive workloads such as artificial intelligence (AI), analytics, high-performance storage, and cloud application services has placed increasing demands on a data system's CPU(s) and other hardware (e.g., memory, I/O, etc.). As an example, managing encrypted data resources has become common practice. Further, applications that involve compression and encryption of data in a single pass can significantly tie up processing resources and add data-flow bottlenecks, leading to increased latency. Indeed, even standard compression algorithms can consume significant CPU resources. To address these and other example issues, an accelerator may be included (e.g., as a standalone accelerator device, built-in (integrated) accelerator, or add-in card), through which certain computationally intensive operations (e.g., symmetric and asymmetric cryptography, data compression/decompression operations, artificial intelligence, reversible data transforms, etc.) can be offloaded from the CPU, allowing computational resources to be reallocated to allow the CPU to perform other tasks more efficiently, potentially enhancing overall system performance, efficiency, and power across various use cases, among other example advantages.

In some implementations, an accelerator device, which may include one or multiple blocks of accelerator hardware, may be used (e.g., at the direction of a CPU, hypervisor, or other logic used to implement an application) to perform one or more jobs for an application. In some implementations, the accelerator device may be offered in a system on chip (SoC) or other platform for utilization within a datacenter or other distributed computing environment, where multiple clients, applications, services, or other tenants may call upon and use the accelerator device and its hardware in connection with one or more jobs. Indeed, the platform may balance or share the concurrent use of the accelerator device and its resources between the multiple tenants. In some implementations, the resources and functionality of the accelerator device may be shared utilizing virtualization techniques such as single root I/O virtualization (SR-IOV), Scalable I/O Virtualization (SIOV), or other example techniques. In some implementations, the balancing and even monetization of a datacenter service offering the accelerator technology may utilize the metrics measuring the use of the accelerator device. As an example, a Service Level Agreements (SLA) may be defined for a tenant, which may include a guarantee that use of a given resource or collection of resources (e.g., including the accelerator hardware) may be made available. For instance, an amount of guaranteed throughput (e.g., measured in Gbps) of an accelerator device may be offered to and guaranteed to a given accelerator device. In one example, other or additional metrics may be measured and tracked to determine a level of utilization of various computing resources, such as accelerator devices, such as the utilization of PCI bandwidth, firmware (e.g., microengines (MEs) of the accelerator device, accelerator hardware modules or blocks (or “slices”), and receive/response buffers (or “ring pairs”), which may be mapped to different virtual functions, virtual devices, or other tenants, among other examples.

While metrics measuring throughput and resource usage (e.g., cycle counts, etc.) may be useful in the management and control of a platform and its components, in some implementations, power consumption may be a superior metric to assess overall utilization of components of a platform and control access to these components (e.g., through throttling or rate-limiting, etc.). Indeed, bandwidth consumption (e.g., measuring the amount of data that is input to or output from a component) may miss instances where the complexity or volume of processing used to consume data that is input or output from the component. For instance, a cryptographic or compression accelerator may utilize different algorithms to perform a corresponding task on an amount of data, and the power consumption may vary considerably based on the algorithm performed, despite providing the same level of throughput (e.g., PCIe in/out bandwidth) and processing time. Indeed, power consumption may be utilized as the basis for tenant's utilization costs associated with the use of one or more components (e.g., hardware accelerators) within a platform.

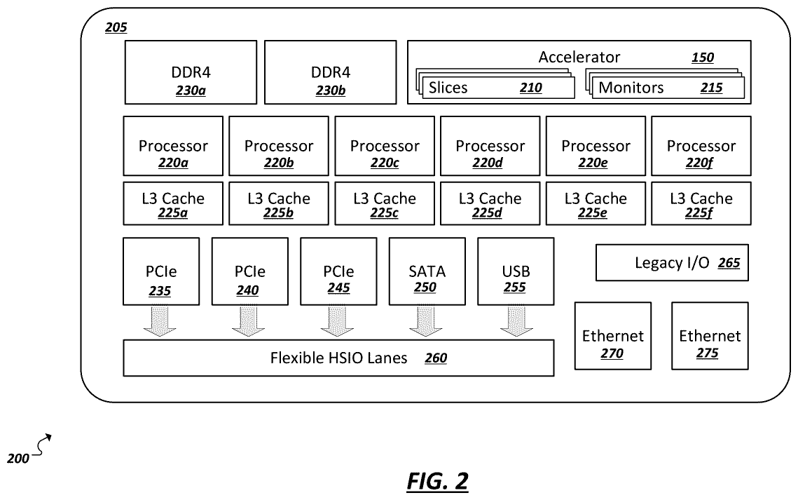

Turning to FIG. 2, a simplified block diagram 200 is shown of an example processing device 205, such as implemented in a system on chip (SoC), processor device, chiplet, motherboard, or another computing platform. In this example, an improved hardware accelerator 150 may be provided, which includes power monitoring circuitry to measure and record, on a per-tenant level, the amount of power consumed by the tenant through its use of the hardware accelerator 150. In cases, where the hardware accelerator (e.g., 150) is integrated within a processing device (e.g., 205), power consumed specifically through use of the hardware accelerator (e.g., separate from the power consumed by other components of the processing device 205 or the processing device overall, may be measured and utilized, for instance, to perform rate limiting, throttling, or other control tasks associated with the use of the processing device 205. For instance, as opposed to throttling a given processing device 205 due to its overall power use (e.g., which may be high given excessive use of an integrated hardware accelerator 150), measuring power consumption specifically at the hardware accelerator (and/or other specific sub-components of the processor device) may allow the individual components (e.g., hardware accelerator 150) responsible for the processor device's high power usage to be throttled, rather than the entire processor, among other example use cases.

Returning to the example of FIG. 2, an example hardware accelerator 150 may include circuitry to implement a set of hardware-accelerated functions. In some implementations, accelerator circuitry may be implemented as multiple “slices” 210 of accelerator hardware, which may each be used (e.g., in parallel with other slices) to perform jobs, which may be assigned to the hardware accelerator 150. The hardware accelerator may additionally include a collection of power monitors (e.g., 215) to measure power consumption at each of the hardware slices 210 and other components of the hardware accelerator 150 in order to determine at a per-job or per-tenant level the power consumed at the hardware accelerator, among other example features and uses. perform compression and decompression of data according to one or multiple lossless compression The hardware accelerator 150 allows for various operations to be offloaded from the general purpose processing cores (e.g., CPUs), which may otherwise be called upon to perform such operations (e.g., through the execution of corresponding software or firmware code). In this example, the data processing system 205 may include one more processor devices 220a-f with corresponding cache blocks 225a-f (e.g., level 3 (L3) cache). System memory 230a-b (e.g., implemented using DDR4 memory blocks) may be provided and further used by the processors 225a-f and hardware accelerator 150, among other elements of the data processing system. In some implementations, source and destination buffers may be implemented in system memory 230a-b. I/O circuitry may be provided to couple components to the memory 203a-b. Additional I/O circuitry (e.g., 235, 240, 245, 250, 255, 265, 270, 275) may be provided to allow the data processing system 205 to interface and communicate with external devices, for instance, over flexible high speed I/O (HSIO) lanes 260.

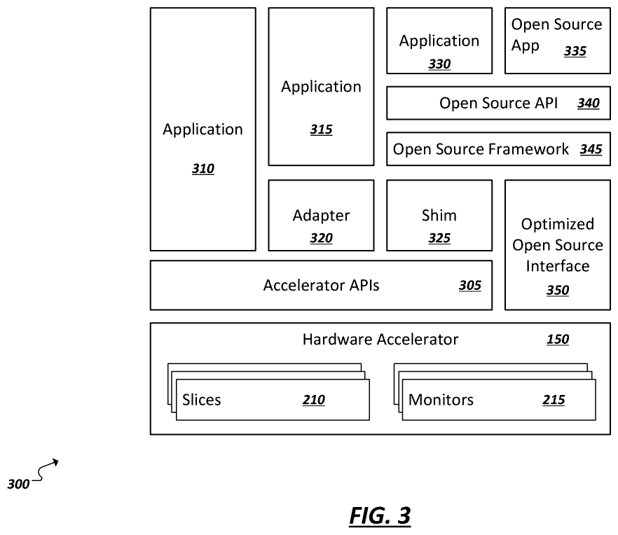

Turning to the simplified block diagram 300 in FIG. 3, a representation of a logic stack for implementing applications (e.g., 310, 315, 330, 335), which may leverage the functionality of hardware accelerator 150. In some implementations, one or more application programming interfaces (APIs) may be provided to allow applications to request the hardware accelerator to perform, using the hardware circuitry of the hardware accelerator 150, one or more accelerated tasks in association with one or more threads or jobs associate with an application. Some applications (e.g., 310) may directly access the accelerator API 305, while other applications (e.g., 315, 330, 335, etc.) may utilize adapters (e.g., 320), shims (e.g., 325), open source APIs and adapters (e.g., 340, 345, 350), among other example features and implementations. In some implementations, the accelerator API 305 may be utilized to cause specific firmware to be loaded onto the hardware accelerator, to define specific SLA thresholds and policies (e.g., associated with power consumption by jobs using the hardware accelerator), and accessing data describing power consumption metrics and other utilization metrics collected at the hardware accelerator, among other example uses.

In some implementations, an orchestrator or other controller may monitor use of a computing platform in connection with a datacenter or cloud computing service, among other examples. For instance, various services levels (e.g., as defined in a service level agreement or quality of service (QoS) agreement, etc.) may be guaranteed, maintained, or enforced using the orchestrator. Further, consumption of resources of the datacenter service may be tracked in order to report energy usage to various tenants and/or bill tenants or clients based on their usage of the datacenter's resources, including various processors, accelerators, network controllers, etc. In some implementations, accelerator-level power monitors may be utilized, such as discussed herein, to allow service levels and billing terms to be defined that incorporate or consider power consumption of various specialized accelerators or other hardware resources within the datacenter system, among other example features.

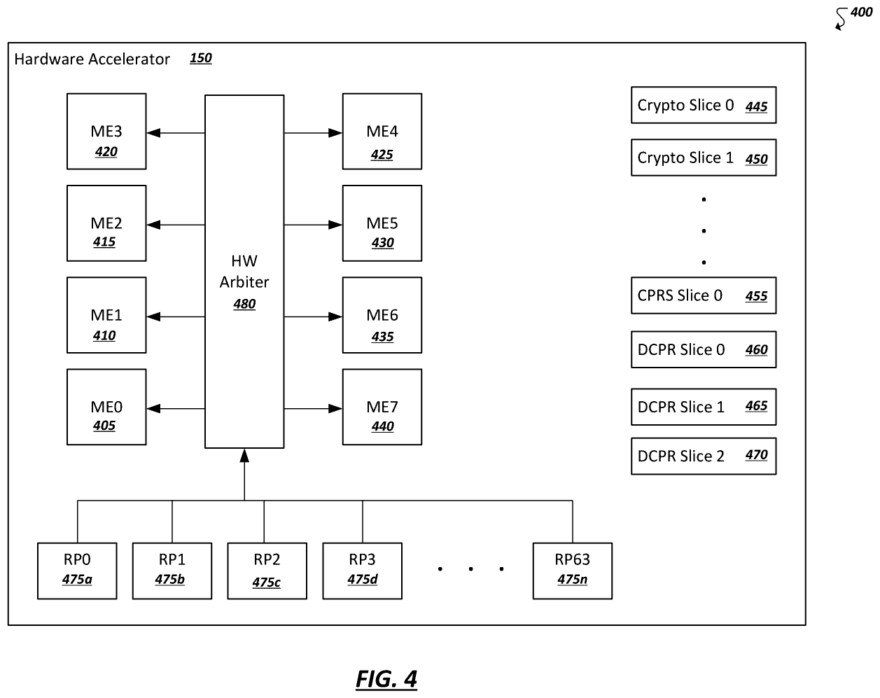

Turning to the simplified block diagram 400 of FIG. 4, an example architecture of an example hardware accelerator 150 is shown. In this example, a collection of multiple microengines (MEs) (e.g., 405, 410, 415, 420, 425, 430, 435, 440) are provided. A microengine (ME) may include processing circuitry and memory, the processing circuitry configured to execute various firmware images loaded onto the ME. A firmware image loaded onto an ME may provide the logic executable by the ME to manage the performance of various jobs using one or more of the various accelerator hardware slices (e.g., 445, 450, 455, 460, 465, 470, etc.) provided on the hardware accelerator 150. An arbiter block 480 may be provided to organize and direct the assignment of individual jobs to various collections of one or more MEs (e.g., 405, 410, 415, 420, 425, 430, 435, 440) and one or more hardware slices (e.g., 445, 450, 455, 460, 465, 470, etc.) of the hardware accelerator.

In the example of FIG. 4, an example hardware accelerator is presented with acceleration hardware to perform cryptography and compression/decompression. For instance, a subset of the hardware slices (e.g., 445, 450) may implement cryptography acceleration, another subset of the hardware slices (e.g., 455) data compression, and another subset of hardware slices (e.g., 460, 465, 470) corresponding decompression. MEs may be loaded with firmware, in this example, to perform cryptographic operations (and use cryptography slices 445, 450) or alternatively be loaded with different firmware (e.g., at boot time) to perform compression/decompression operations. In some runtime sessions, different MEs may be loaded with cryptography firmware and others with compression/decompression firmware in this example. In other instances, all of the MEs may be loaded with either cryptography firmware (e.g., when it is expected that all workloads will be cryptography-focused (with compression and decompression slices remaining idle during the session)) or compression/decompression firmware (e.g., when the workloads during the session are expected to be compression and decompression), among other examples. In other example implementations, all of the hardware slices may be instances of the same block of accelerator hardware, allowing multiple tenants to simultaneously access and use respective hardware slices to perform similar types of operations (e.g., cryptography, graphics processing, network management, memory management, compression/decompression, AI inferences, etc.). In such implementations, each of the MEs may be loaded with the same or similar firmware to manage jobs performed using the hardware slice instances, among other example implementations.

Continuing with the example of FIG. 4, one or more interfaces may be provided (e.g., ports compatible with an interconnect protocol (e.g., PCIe, CXL, NVLink, UCIe, etc.)) to allow the hardware accelerator 150 to couple one or more other devices. For instance, one or multiple CPU nodes may couple to and communicate with the hardware accelerator in connection with applications, services, or microservices executed on the processors, with jobs being sent to the hardware accelerator where appropriate or desired. The hardware accelerator 150 may include memory to implement a collection of queues or buffers, such as ring buffer pairs (e.g., 475a-n). A ring buffer may be associated with or mapped to a particular ME and/or a particular tenant associated with a given job to be executed using the MEs and hardware slices of the hardware accelerator 150. A ring pair may include a first buffer, or request buffer, to accept requests from a tenant associated with a job. Requests held in the request buffer may point to memory (e.g., system memory, DDR, etc.) where data to be processed using the hardware accelerator is stored. A ring pair may additionally include a response buffer to hold the responses or results of processing of requests by the hardware accelerator 150. The responses in the response buffer correspond to requests in the request buffer of the same ring pair. The responses may also include pointers to memory (e.g., DDR) where result payload data is stored.

When a job is received at the hardware accelerator, it may be assigned to one or more MEs (e.g., 415), which may use corresponding firmware and accelerator hardware slices (e.g., 455) to generate completions of various requests associated with a job (e.g., a compression job). A ring pair (e.g., 475d) may be mapped to the job and the requests for handling by the assigned ME and completions/results generated by the ME (using the hardware slices) may be entered in the ring pair 475d. In addition to holding requests and responses in transactions between the hardware accelerator and a tenant, ring pairs may also be used, in some implementations, to store metrics measured at the hardware accelerator, associated with the execution of a job, such as the amount of data throughput in and/or out of the hardware accelerator associated with a job or tenant, the duration of a job or associated tenant's use or “ownership” of an ME or hardware slice, among other example metrics. In other implementations, a separate table, register, or other data structure may be provided (e.g., in addition to the ring pair) to store metrics associated with an RP, tenant, or job, which may be accessed (e.g., by a corresponding ME) in connection with rate limiting, SLA implementations, etc. based on these metrics.

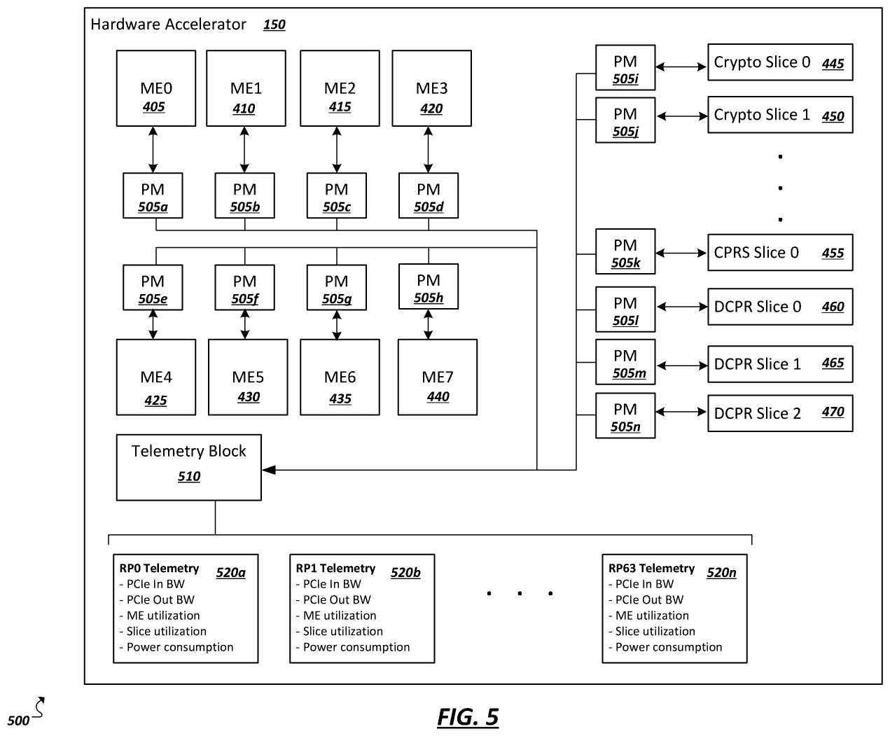

Turning to the example illustrated by the simplified block diagram 500 of FIG. 5, components of an example hardware accelerator (e.g., 150) may be provided with power consumption monitoring circuitry (e.g., 505a-505n) to monitor, at associated components, the amount of power consumed by the components. These power consumption monitoring results may be mapped to individual jobs or tenants and stored along with other metrics. Such metrics may be used to determine fees to bill in association with use of the hardware accelerator and/or to enforce SLA or throttling policies, among other example uses. For instance, in the example of FIG. 5, a hardware accelerator similar to that shown in the example of FIG. 4 is shown with power monitoring circuitry (e.g., 505a-505n) to monitor individual power consumption of each of the MEs (e.g., 405, 410, 415, 420, 425, 430, 435, 440) and each of the hardware slices (e.g., 445, 450, 455, 460, 465, 470). In some implementations, power monitoring circuitry block may be provided for each ME and each hardware slice. In other cases, a power monitoring circuitry block may measure power consumption of multiple MEs and/or hardware slices, among other examples. Accordingly, granular power consumption metrics may be determined (e.g., at the ME and hardware slice level) and mapped to individual jobs, tenants, or ring pairs. For instance, a first job may be assigned to a particular ME (e.g., 430), which may call upon and use a particular hardware slice (e.g., 465) to perform a task (e.g., data decompression in accordance with a particular compression algorithm) associated with the job. Power consumption may be measured during the performance of the task (as well as other tasks associated with the job) by the ME 430 and compression hardware slice 465 and this power consumption information may be stored in a data structure (e.g., 520a-520n) associated with the job or the tenant requesting the job, so as to track job and/or tenant-specific power consumption associated with its use of the hardware accelerator 150. For instance, a telemetry block 510 may be provided to record and manage the recording of metric data (e.g., power-based telemetry data) generated by the power consumption monitors 505a-505n and other monitoring circuitry deployed within the hardware accelerator 150. For instance, as power consumption data is generated by power monitor blocks, this power consumption data may be periodically sent to one or more telemetry blocks (e.g., 510). Telemetry blocks may map hardware accelerator resources (e.g., MEs, accelerator hardware slices, etc.) that are currently used for request processing to a ring pair from which given request originated. This mapping allows the aggregation and tracking of utilization of these resources by each of the ring pairs (e.g., in telemetry data structures (e.g., 520a-520n) associated with each ring pair (e.g., representing a respective job or tenant). In this example, monitoring circuitry and telemetry blocks may be utilized to collect accelerator hardware metric information including granular power consumption information, data throughput information (e.g., PCIe data in and out), duration of ME usage, duration of hardware slice usage, among other example information.

In some implementations, firmware of the hardware accelerator (e.g., firmware loaded in individual MEs used in corresponding jobs or by corresponding tenants) may access metric data from the telemetry block (and corresponding records mapped to ring pairs used by the job or tenant) to determine whether the power consumption of a job or tenants is in compliance with a policy, SLA, or other associated usage threshold or has exceeded the threshold. Policies may be defined for the handling of conditions where a given job or tenants has exceeded a threshold level of power consumption (e.g., within a given window of time). In some implementations, thresholds and policies may incorporate and involve the assessment of combinations of metrics, such as power consumption and bandwidth utilized, power consumption over an amount of time using a given ME or hardware slice, among other examples. In some implementations, thresholds and policies may be defined at the job, tenant, and/or customer level (e.g., in accordance with associated customer-specific SLAs). For instance, a register, table, or other data structure may be provided and accessed (e.g., by software via an API) to define specific power consumption thresholds that are to be applied to corresponding jobs and/or tenants. Such definitions may also define the consequences and handling of instances where a job or tenant exceeds the allowed threshold amount of power consumption. For instance, rate limiting or throttling of a job or tenants may be triggered based on a determination that a threshold level of power consumption by a job has been exceeded. Such throttling may include, for instance, blocking or throttling subsequent requests from an associated client or tenants using various techniques (e.g., throttling a corresponding communication link, temporarily disabling or blocking the receive ring pair used by the client to push new tasks to the hardware accelerator, among other examples), which may be initiated, in some implementations, using hardware accelerator MEs (e.g., associated with the job being throttled). In some instances, different thresholds and throttling techniques may be applied to different customers using the same hardware accelerator, among other example features. In some implementations, an application programming interface (API) may be provided and defined for use with the power usage monitoring characteristics of the hardware accelerator (e.g., which an application may utilize to message or access information from the hardware accelerator or a usage controller provided for use with the hardware accelerator (e.g., which may drive or control access to the hardware accelerator's resources by of various specific jobs based on the measured power usage information), among other example implementations.

In addition to allowing rate limiting, the definition of SLAs (e.g., through an SLA API of the hardware accelerator), customer billing models based on accelerator power consumption, the power consumption metrics generated by the power monitoring blocks may be exposed by telemetry data to allow tenants using the hardware accelerator to tune their respective applications to use less power. The resultant power savings may assist in implementing carbon-neutral computing and providing more energy efficient data center environments, among other example benefits. For instance, thresholds and policies governing the use and access to the resources of a hardware accelerator device may be based on the type of energy being used to power the accelerator device (e.g., with higher thresholds allowed when renewable energy is used, and lower thresholds defined for windows of time when non-renewable energy is used, etc.), among other examples.

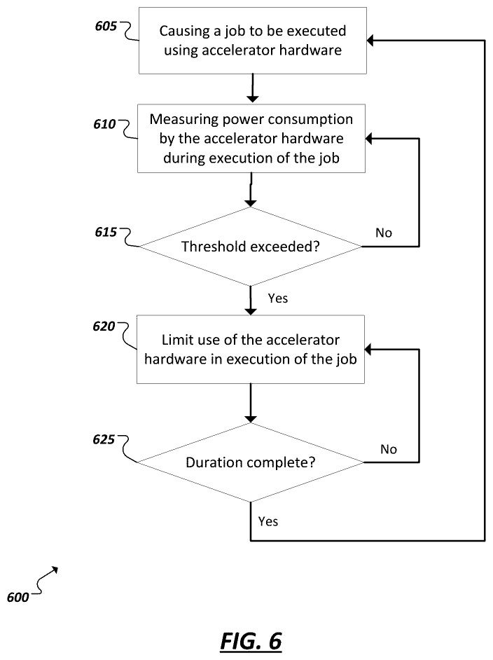

FIG. 6 is a simplified flow diagram 600 illustrating an example technique for monitoring power consumption at a hardware accelerator, such as a hardware accelerator integrated on a die with a general purpose processor (e.g., a multi-core CPU). For instance, a job may be caused to be executed 605 on the hardware accelerator and may be assigned to and executed using specific hardware components of the hardware accelerator (e.g., specific microengines loaded with specific firmware, specific hardware slices (which may be accessed and used at the direction of the microengine(s), etc.). Power consumption may be measured 610 at these hardware components using corresponding power consumption monitoring blocks (e.g., implemented in hardware), and the measured power consumption may be associated with the job and/or a tenant or client associated with the job (e.g., where the job is part of a larger application, service, or microservice executed by the tenant or client). Aggregate power consumption (e.g., over a window of time or a session) may be measured, recorded, and monitored to determine (e.g., at 615) whether a defined threshold level of power has been consumed through the job's use of the hardware accelerator. In some implementations, a usage controller may be provided (e.g., implemented in software (e.g., executed on general purpose processor) or on the accelerator device itself (e.g., as a dedicated hardware block or in firmware)), which may access power usage telemetry data collected at the accelerator device and may control access to the accelerator device based on the power usage data and whether a corresponding power usage threshold has been met or exceeded. For instance, if the threshold has been exceeded, a policy may be identified for the job, which may be utilized (e.g., by the hardware accelerator or an external orchestrator) to limit 620 use additional or continued use of the hardware accelerator by the job, a tenant, or a client (associated with the job). This limiting may be temporary, so as to throttle the utilization rate of the hardware accelerator by a given tenant or customer for a duration of time. When the duration of the throttling or rate limiting is complete (e.g., at 625), the client, tenant, or job may be permitted to again make full use of hardware accelerator (e.g., until another instance of related power consumption is determined to again exceed the defined threshold), among other example features.

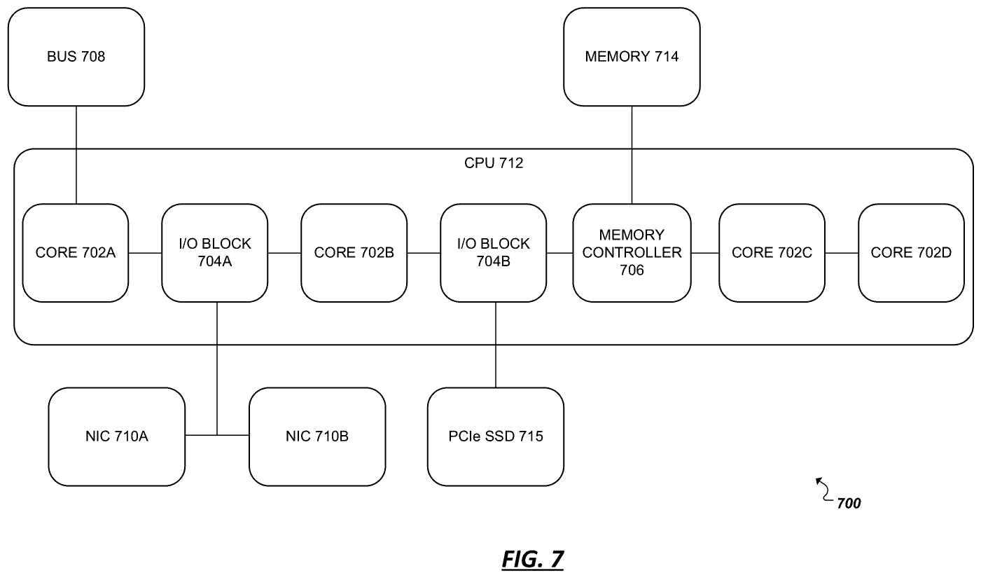

Note that the apparatus', methods', and systems described above may be implemented in any electronic device or system as aforementioned. More particularly, a preprocessing hardware accelerator, such as discussed herein, may be coupled to or integrated in a variety of different electronic devices or system to offload certain preprocessing tasks, including data reduction operations, from other processing hardware (e.g., a CPU) of the system. As a specific illustration, FIG. 7 provides an exemplary implementation of a processing device such as one that may be include or be coupled to and use a preprocessing hardware accelerator (e.g., to offload workloads to). It should be appreciated that other processor architectures may be provided to implement the functionality and processing of requests by an example network processing device, including the implementation of the example network processing device components and functionality discussed above. Further, while the examples discussed above focus on improvements to an Ethernet subsystem and links compliant with an Ethernet-based protocol, it should be appreciated that the principles discussed herein are protocol agnostic and may be applied to interconnects based on a variety of other technologies, such as PCIe, CXL, UCIe, CCIX, Infinity Fabric, among other examples.

Referring to FIG. 7, a block diagram 700 is shown of an example data processor device (e.g., a central processing unit (CPU)) 712 coupled to various other components of a platform in accordance with certain embodiments. Although CPU 712 depicts a particular configuration, the cores and other components of CPU 712 may be arranged in any suitable manner. CPU 712 may comprise any processor or processing device, such as a microprocessor, an embedded processor, a digital signal processor (DSP), a network processor, an application processor, a co-processor, a system on a chip (SOC), or other device to execute code. CPU 712, in the depicted embodiment, includes four processing elements (cores 702 in the depicted embodiment), which may include asymmetric processing elements or symmetric processing elements. However, CPU 712 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 712, as illustrated in FIG. 7, includes four cores-cores 702A, 702B, 702C, and 702D, though a CPU may include any suitable number of cores. Here, cores 702 may be considered symmetric cores. In another embodiment, cores may include one or more out-of-order processor cores or one or more in-order processor cores. However, cores 702 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 702 may include a decode module coupled to a fetch unit to decode fetched elements. Fetch logic, in one embodiment, includes individual sequencers associated with thread slots of cores 702. Usually a core 702 is associated with a first ISA, which defines/specifies instructions executable on core 702. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 702 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 702, in one embodiment, recognize the same ISA (or a subset thereof). Alternatively, in a heterogeneous core environment, a decoder of one or more cores (e.g., core 702B) may recognize a second ISA (either a subset of the first ISA or a distinct ISA).

In various embodiments, cores 702 may also include one or more arithmetic logic units (ALUs), floating point units (FPUs), caches, instruction pipelines, interrupt handling hardware, registers, or other suitable hardware to facilitate the operations of the cores 702.

Bus 708 may represent any suitable interconnect coupled to CPU 712. In one example, bus 708 may couple CPU 712 to another CPU of platform logic (e.g., via UPI). I/O blocks 704 represents interfacing logic to couple I/O devices 710 and 715 to cores of CPU 712. In various embodiments, an I/O block 704 may include an I/O controller that is integrated onto the same package as cores 702 or may simply include interfacing logic to couple to an I/O controller that is located off-chip. As one example, I/O blocks 704 may include PCIe interfacing logic. Similarly, memory controller 706 represents interfacing logic to couple memory 714 to cores of CPU 712. In various embodiments, memory controller 706 is integrated onto the same package as cores 702. In alternative embodiments, a memory controller could be located off chip.

As various examples, in the embodiment depicted, core 702A may have a relatively high bandwidth and lower latency to devices coupled to bus 708 (e.g., other CPUs 712) and to NICs 710, but a relatively low bandwidth and higher latency to memory 714 or core 702D. Core 702B may have relatively high bandwidths and low latency to both NICs 710 and PCIe solid state drive (SSD) 715 and moderate bandwidths and latencies to devices coupled to bus 708 and core 702D. Core 702C would have relatively high bandwidths and low latencies to memory 714 and core 702D. Finally, core 702D would have a relatively high bandwidth and low latency to core 702C, but relatively low bandwidths and high latencies to NICs 710, core 702A, and devices coupled to bus 708.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, HDL, and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of a system on chip (SoC) and other hardware devices. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, such as reset, while an updated value potentially includes a low logical value, such as set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: accelerator hardware, where the accelerator hardware includes a first component to be used in execution of a first job; first power monitoring circuitry to monitor power consumption at the first component associated with execution of the first job; and a usage controller to limit use of the accelerator hardware in association with the first job based at least in part on the measured power consumption at the first component associated with execution of the first job.

Example 2 includes the subject matter of example 1, where the accelerator hardware further includes: a second component to be used in execution of a second job; and second power monitoring circuitry to measure power consumption at the second component associated with execution of the second job.

Example 3 includes the subject matter of example 2, further including memory, where a plurality of buffers are to be implemented in the memory, the first job is to be mapped to a first one of the plurality of buffers, the second job is to be mapped to a second one of the plurality of buffers, requests associated with the first job are to be entered in the first buffer, and requests associated with the second job are to be entered in the second buffer.

Example 4 includes the subject matter of example 3, where power consumption measured based on the first job and the second job is mapped respectively to the first buffer and the second buffer.

Example 5 includes the subject matter of any one of examples 2-4, where the usage controller is to further allow continued use of the second components of the accelerator hardware by the second job while use of the accelerator hardware by the first job is limited based on the measured power consumption at the second component associated with execution of the second job.

Example 6 includes the subject matter of any one of examples 2-5, where the usage controller is to monitor whether power consumption by jobs exceeds at least one threshold, and the use of the accelerator hardware by the first job is limited based on a determination that the measured power consumption at the first component associated with execution of the first job exceeds the threshold.

Example 7 includes the subject matter of example 6, where the at least one threshold includes a plurality of different power consumption thresholds, a first one of the plurality of thresholds is applied to the first job, and a second one of the plurality of thresholds is applied to the second job.

Example 8 includes the subject matter of 7, where the first threshold is based on a first service level agreement and the second threshold is based on a second service level agreement.

Example 9 includes the subject matter of any one of examples 2-8, where the first component includes a first microengine and a first hardware slice, the first microengine executes firmware to use the first hardware slice in execution of the first job, the second component includes a second microengine and a second hardware slice, the second microengine executes firmware to use the second hardware slice in execution of the second job.

Example 10 includes the subject matter of example 9, where the first power monitoring circuitry includes a first power monitor to measure power consumption at the first microengine and a second power monitor to measure power consumption at the first hardware slice, and the second power monitoring circuitry includes a third power monitor to measure power consumption at the second microengine and a fourth power monitor to measure power consumption at the second hardware slice, where power consumption measured for the first job includes power consumed by the first microengine as measured by the first power monitor and power consumed by the first hardware slice as measured by the second power monitor, and power consumption measured for the second job includes power consumed by the second microengine as measured by the third power monitor and power consumed by the second hardware slice as measured by the fourth power monitor.

Example 11 includes the subject matter of any one of examples 9-10, where the first hardware slice is configured to accelerate a first operation and the second hardware slice is configured to accelerate a different second operation.

Example 12 includes the subject matter of any one of examples 1-11, where the accelerator hardware includes hardware to accelerate at least one of an encryption operation, a data compression operation, a machine learning operation, a graphics processing operation, or a networking operation.

Example 13 includes the subject matter of any one of examples 1-12, further including a central processing unit (CPU), where the CPU and the hardware accelerator are integrated on a same die, and the first job originates from an application executed on the CPU.

Example 14 is a method including: identifying a job to be executed using accelerator hardware on a computing device; measuring power consumption by the accelerator hardware during execution of the job; determining that an amount of power consumed by the accelerator hardware during execution of the job exceeds a threshold; and limiting use of the accelerator hardware during execution of the job for a duration based on determining that the amount of power exceeds the threshold.

Example 15 includes the subject matter of example 14, further including: determining that the duration has completed; and reviving use of the accelerator hardware during execution of the job.

Example 16 includes the subject matter of example 14, where limiting use of the accelerator hardware includes temporarily disabling a receive buffer associated with the job.

Example 17 includes the subject matter of example 14, where the job is executed using a plurality of hardware components of the accelerator, power consumption of each of the plurality of hardware components is measured, and the amount of power includes combined power consumption of the plurality of hardware components during execution of the job.

Example 18 includes the subject matter of any one of examples 14-17, further including: measuring power consumption by a first portion of the accelerator hardware during execution of another job; and determining whether access to the accelerator hardware by the other job should be limited based an amount of power consumed by the accelerator hardware during execution of the other job.

Example 19 includes the subject matter of example 18, where a second portion of the accelerator hardware is used during execution of the job.

Example 20 includes the subject matter of any one of examples 18-19, where the job and other job are executed at least partially in parallel on the accelerator hardware.

Example 21 includes the subject matter of any one of examples 14-20, where the accelerator hardware includes hardware of the hardware accelerator in any one of examples 1-13.

Example 22 is a system including means to perform the method of any one of examples 14-21.

Example 23 is a system including: a processor to execute an application, where the application includes a job; a hardware accelerator, where the job is to be offloaded from the processor to the hardware accelerator, and the hardware accelerator includes: a first component to be used in execution of the job; first power monitoring circuitry to monitor power consumption at the first component associated with execution of the job; and a usage controller to limit use of the hardware accelerator in association with the first job based at least in part on the measured power consumption at the first component associated with execution of the job.

Example 24 includes the subject matter of example 23, where the hardware accelerator further includes memory to implement a buffer pair, the buffer pair includes a receive buffer and a response buffer, the buffer pair is to be mapped to the job, where requests from the processor to the hardware accelerator associated with the job are to be written to the receive buffer, and responses to the requests generated by the hardware accelerator are to be written to the response buffer.

Example 25 includes the subject matter of any one of examples 23-24, where the hardware accelerator includes a plurality of accelerator hardware slices and a plurality of power consumption monitoring blocks, power consumption is measured for respective accelerator hardware slices in the plurality of accelerator hardware slices by respective ones of the plurality of power consumption monitoring blocks.

Example 26 includes the subject matter of any one of examples 23-25, where the hardware accelerator further includes: a second component to be used in execution of a second job; and second power monitoring circuitry to measure power consumption at the second component associated with execution of the second job.

Example 27 includes the subject matter of example 26, further including memory, where a plurality of buffers are to be implemented in the memory, the first job is to be mapped to a first one of the plurality of buffers, the second job is to be mapped to a second one of the plurality of buffers, requests associated with the first job are to be entered in the first buffer, and requests associated with the second job are to be entered in the second buffer.

Example 28 includes the subject matter of example 27, where power consumption measured based on the first job and the second job is mapped respectively to the first buffer and the second buffer.

Example 29 includes the subject matter of any one of examples 26-28, where the usage controller is to further allow continued use of the second components of the accelerator hardware by the second job while use of the accelerator hardware by the first job is limited based on the measured power consumption at the second component associated with execution of the second job.

Example 30 includes the subject matter of any one of examples 26-29, where the usage controller is to monitor whether power consumption by jobs exceeds at least one threshold, and the use of the accelerator hardware by the first job is limited based on a determination that the measured power consumption at the first component associated with execution of the first job exceeds the threshold.

Example 31 includes the subject matter of example 30, where the at least one threshold includes a plurality of different power consumption thresholds, a first one of the plurality of thresholds is applied to the first job, and a second one of the plurality of thresholds is applied to the second job.

Example 32 includes the subject matter of 31, where the first threshold is based on a first service level agreement and the second threshold is based on a second service level agreement.

Example 33 includes the subject matter of any one of examples 26-32, where the first component includes a first microengine and a first hardware slice, the first microengine executes firmware to use the first hardware slice in execution of the first job, the second component includes a second microengine and a second hardware slice, the second microengine executes firmware to use the second hardware slice in execution of the second job.

Example 34 includes the subject matter of example 33, where the first power monitoring circuitry includes a first power monitor to measure power consumption at the first microengine and a second power monitor to measure power consumption at the first hardware slice, and the second power monitoring circuitry includes a third power monitor to measure power consumption at the second microengine and a fourth power monitor to measure power consumption at the second hardware slice, where power consumption measured for the first job includes power consumed by the first microengine as measured by the first power monitor and power consumed by the first hardware slice as measured by the second power monitor, and power consumption measured for the second job includes power consumed by the second microengine as measured by the third power monitor and power consumed by the second hardware slice as measured by the fourth power monitor.

Example 35 includes the subject matter of any one of examples 33-34, where the first hardware slice is configured to accelerate a first operation and the second hardware slice is configured to accelerate a different second operation.

Example 36 includes the subject matter of any one of examples 23-35, where the accelerator hardware includes hardware to accelerate at least one of an encryption operation, a data compression operation, a machine learning operation, a graphics processing operation, or a networking operation.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
accelerator hardware, wherein the accelerator hardware comprises a first component to be used in execution of a first job;
first power monitoring circuitry to monitor power consumption at the first component associated with execution of the first job; and
telemetry circuitry to record power usage data to identify measured power consumption at the first component associated with execution of the first job.

2. The apparatus of claim 1, wherein the accelerator hardware further comprises:
a second component to be used in execution of a second job; and
second power monitoring circuitry to measure power consumption at the second component associated with execution of the second job.

3. The apparatus of claim 2, further comprising memory, wherein a plurality of buffers are to be implemented in the memory, the first job is to be mapped to a first one of the plurality of buffers, the second job is to be mapped to a second one of the plurality of buffers, requests associated with the first job are to be entered in the first buffer, and requests associated with the second job are to be entered in the second buffer.

4. The apparatus of claim 3, wherein power consumption measured based on the first job and the second job is mapped respectively to the first buffer and the second buffer.

5. The apparatus of claim 2, further comprising a usage controller to limit use of the accelerator hardware in association with the first job based at least in part on the measured power consumption at the first component associated with execution of the first job.

6. The apparatus of claim 5, wherein the usage controller is to further allow continued use of the second components of the accelerator hardware by the second job while use of the accelerator hardware by the first job is limited based on the measured power consumption at the second component associated with execution of the second job.

7. The apparatus of claim 5, wherein the usage controller is to monitor whether power consumption by jobs exceeds at least one threshold, and the use of the accelerator hardware by the first job is limited based on a determination that the measured power consumption at the first component associated with execution of the first job exceeds the threshold.

8. The apparatus of claim 7, wherein the at least one threshold comprises a plurality of different power consumption thresholds, a first one of the plurality of thresholds is applied to the first job, and a second one of the plurality of thresholds is applied to the second job.

9. The apparatus of claim 8, wherein the first threshold is based on a first service level agreement and the second threshold is based on a second service level agreement.

10. The apparatus of claim 2, wherein the first component comprises a first microengine and a first hardware slice, the first microengine executes firmware to use the first hardware slice in execution of the first job, the second component comprises a second microengine and a second hardware slice, the second microengine executes firmware to use the second hardware slice in execution of the second job.

11. The apparatus of claim 10, wherein the first power monitoring circuitry comprises a first power monitor to measure power consumption at the first microengine and a second power monitor to measure power consumption at the first hardware slice, and the second power monitoring circuitry comprises a third power monitor to measure power consumption at the second microengine and a fourth power monitor to measure power consumption at the second hardware slice, wherein power consumption measured for the first job comprises power consumed by the first microengine as measured by the first power monitor and power consumed by the first hardware slice as measured by the second power monitor, and power consumption measured for the second job comprises power consumed by the second microengine as measured by the third power monitor and power consumed by the second hardware slice as measured by the fourth power monitor.

12. The apparatus of claim 10, wherein the first hardware slice is configured to accelerate a first operation and the second hardware slice is configured to accelerate a different second operation.

13. The apparatus of claim 1, wherein the accelerator hardware comprises hardware to accelerate at least one of an encryption operation, a data compression operation, a machine learning operation, a graphics processing operation, or a networking operation.

14. A method comprising:
identifying a job to be executed using accelerator hardware on a computing device;
measuring power consumption by the accelerator hardware during execution of the job;
determining that an amount of power consumed by the accelerator hardware during execution of the job exceeds a threshold; and
limiting use of the accelerator hardware during execution of the job for a duration based on determining that the amount of power exceeds the threshold.

15. The method of claim 14, further comprising:
determining that the duration has completed; and
reviving use of the accelerator hardware during execution of the job.

16. The method of claim 14, wherein limiting use of the accelerator hardware comprises temporarily disabling a receive buffer associated with the job.

17. The method of claim 14, wherein the job is executed using a plurality of hardware components of the accelerator, individual power consumption of individual hardware components in the plurality of hardware components is measured, and the amount of power comprises combined power consumption of the plurality of hardware components during execution of the job.

18. A system comprising:
a processor to execute an application, wherein the application comprises a job;
a hardware accelerator, wherein the job is to be offloaded from the processor to the hardware accelerator, and the hardware accelerator comprises:
a first component to be used in execution of the job;
first power monitoring circuitry to monitor power consumption at the first component associated with execution of the job; and
a usage controller to limit use of the hardware accelerator in association with the first job based at least in part on the measured power consumption at the first component associated with execution of the job.

19. The system of claim 18, wherein the hardware accelerator further comprises memory to implement a buffer pair, the buffer pair comprises a receive buffer and a response buffer, the buffer pair is to be mapped to the job, wherein requests from the processor to the hardware accelerator associated with the job are to be written to the receive buffer, and responses to the requests generated by the hardware accelerator are to be written to the response buffer.

20. The system of claim 18, wherein the hardware accelerator comprises a plurality of accelerator hardware slices and a plurality of power consumption monitoring blocks, power consumption is measured for respective accelerator hardware slices in the plurality of accelerator hardware slices by respective ones of the plurality of power consumption monitoring blocks.
